(19) United States
(12) Patent Application Publication
(10) Pub. No.: US 2004/0197756 A1
(43) Pub. Date: Oct. 7, 2004

(54) Teaching material including connected bottles

(76) Inventor: Yeo-Hyung Yun, Seoul (KR)

Correspondence Address: BURNS DOANE SWECKER & MATHIS L L P, POST OFFICE BOX 1404, ALEXANDRIA, VA, 22313-1404, US

(21) Appl. No.: 10/735,632

(22) Filed: Dec. 16, 2003

Related U.S. Application Data
(63) Continuation of application No. 09/683,901, filed on Feb. 28, 2002, now abandoned.

(51) Int. Cl. G09B 19/00

(52) U.S. Cl. 434/259

(57) ABSTRACT

A multipurpose connector member for connecting PET bottles, which has an upper part forming a liquid outlet mouth to be sealed with stopper; the cylindrical side wall; and a lower part having a concave area or a recessive on the beneath surface is provided, in which another liquid outlet mouth to be sealed with stopper is provided downwards at the center portion of the said concave area or the recessive beneath the bottle, or a symmetrical shape of liquid outlet mouth portion corresponding to the said liquid outlet mouth 11 is extended in the integrated manner from the cylindrical side wall, whereby approaching the desired shape of construction by connecting the said PET bottles and separately the various shapes of connector members and/or subsidiary connector members into an appropriate feature for the purpose.

The present invention is a continuation of U.S. patent application Ser. No. 09/683,901, filed Feb. 28, 2002, and which is incorporated by reference.

### BACKGROUND OF THE INVENTION

1. Field of the Invention

The present invention relates to a multipurpose connector member for connecting PET bottles, particularly to a teaching material consisting of many PET bottles and connector member, and the multipurpose connector member for connecting for improving the creativeness of children and adolescent students, in which the PET bottle has an upper part forming a liquid outlet mouth to be sealed with stopper; the cylindrical side wall; and a lower part having a concave area or a recessive on the beneath surface, in which another liquid outlet mouth to be sealed with stopper is provided downwards at the center portion of the said concave area or the recessive beneath the bottle 10, or a symmetrical shape of liquid outlet mouth portion corresponding to the said liquid outlet mouth is extended in the integrated manner from the cylindrical side wall, whereby approaching the desired shape of construction by connecting the said PET bottles and separately the various shapes of connector members and/or subsidiary connector members into an appropriate feature for the purpose.

2. Description of the Related Art

In general, the conventional type of PET (Polyethylene terepthalate) bottles having only a liquid outlet mouth at their upper area have been used for containing a certain liquid material such as beverage, however, after use, they had to be wasted or collected for reproduction.

Recently, however, as seen from FIG. 1 attached to the present application, some examples have been proposed to re-use the used PET bottles as the water-rocket (100), in which the air-filling chamber (100a) is filled with water and air, and which used to be positioned onto the separated ranching ramp (200) to blastoff the water-rocket. In order to manufacture a water-rocket by use of the conventional PET bottles (10), two or more number of bottles were consumed, and an amount of labor was required for cutting each bottle at an appropriate point of upper or lower part of themselves, and for attaching each of them together by use of strong adhesives or adhesive tapes.

Therefore, there was some danger of accident possibly caused from using a sharp knife during the said cutting process of PET bottles (10), as well as the troublesome process of manufacturing.

Furthermore, some problems have also been incurred that during manufacturing or using the water-rocket made by using the PET bottles, the adhesives or adhesive tapes were detached from the substrate of bottles, resulting in the unusable state, which cannot be repaired.

Moreover, since those conventional PET bottles were intended to fit the purpose of water-rocket, they could not have been used for the other purposes, and only had a limited area of application.

### SUMMARY OF THE INVENTION

Accordingly, the present invention has been made in an effort to solve the problems occurring in the related art, and it is an object of the present invention to provide a PET bottle having a changed structure rather than the conventional bottles in order to be connected and assembled with the other bottles to consist a various shapes and/or configurations which can be used for multiple purpose.

It is another object of the present invention to provide a connector member and subsidiary connector member which can connect and assemble the PET bottle having a changed structure according to the present invention.

It is still another object of the present invention to provide a teaching material consisting of many PET bottles and connector members in attention to forms a desired shape or configuration of substances.

### BRIEF DESCRIPTION OF THE DRAWINGS

The above objects, and other features and advantages of the present invention will become more apparent after a reading of the following detailed description when taken in conjunction with the drawings, in which:

FIG. 1 depicts an example showing a use of PET bottle as the water rocket according to the prior art;

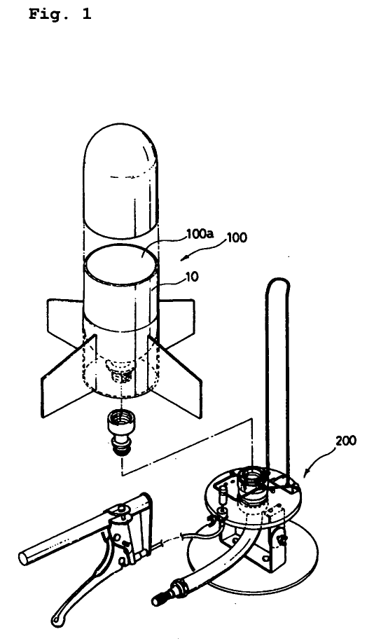

FIG. 2 depicts the configuration of PET bottle used in a preferable embodiment according to the present invention;

FIG. 3 depicts the configuration of linear type of connector member according to a preferable embodiment of the present invention;

FIG. 4 depicts the configuration of polygonal type of connector member according to a preferable embodiment of the present invention;

FIG. 5 depicts the configuration of polyhedral type of connector member according to a preferable embodiment of the present invention;

FIG. 6 depicts the configuration of subsidiary connector member according to a preferable embodiment of the present invention;

FIG. 7 depicts the configuration of the other subsidiary connector member according to another embodiment of the present invention;

FIG. 8 depicts the configuration of the other subsidiary connector member according to further embodiment of the present invention;

FIG. 9 depicts an exampled use of PET bottles as the water rocket, in which the bottles are connected by use of connector members according to the invention;

FIG. 10a depicts an exampled use of PET bottles as the floating mat, in which the bottles are connected by use of connector members according to the invention;

FIG. 10b depicts an exampled use of PET bottles as the raft, in which the bottles are connected by use of connector members according to the invention; and

FIG. 11 depicts an exampled use of PET bottles to build an assembled structure for improving the creativeness of children, in which the bottles are connected by use of connector members according to the invention.

### DETAILED DESCRIPTION OF PREFERRED EMBODIMENTS

The above and other objects, characteristics, and advantages of the present invention will be apparent from the following description along with the accompanying drawings.

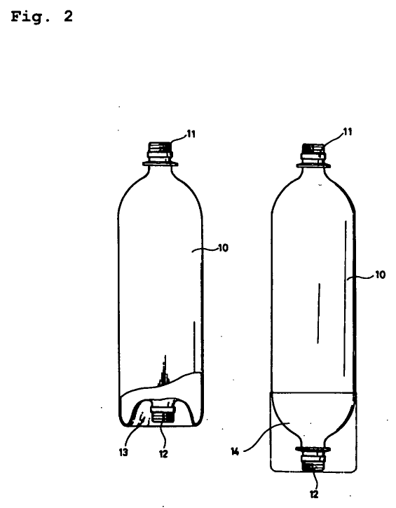

According to a preferred embodiment of the present invention, referring to FIG. 2, provided is a multipurpose connector member for connecting PET bottles 10, which has an upper part forming a liquid outlet mouth 11 to be sealed with stopper (not shown); the cylindrical side wall; and a lower part 13 having a concave area or a recessive on the beneath surface, in which another liquid outlet mouth 12 to be sealed with stopper is provided downwards at the center portion of the said concave area or the recessive beneath the bottle 10, or a symmetrical shape of liquid outlet mouth portion corresponding to the said liquid outlet mouth 11 is extended in the integrated manner from the cylindrical side wall, whereby approaching the desired shape of construction by connecting the said PET bottles and separately the various shapes of connector members and/or subsidiary connector members into an appropriate feature for the purpose.

According to another preferred embodiment of the present invention, the multipurpose connector member for connecting PET bottles 10 comprises a linear type of connector, both ends of which is provided with the screw type of engaging means.

According to the other preferred embodiment of the present invention, the multipurpose connector member for connecting PET bottles 10 comprises a polygonal type of connector having the corresponding number of branches with the various angles between themselves, each end of which is provided with at least two screw sections.

According to further preferred embodiment of the present invention, the multipurpose connector member for connecting PET bottles 10 comprises a polyhedral type of connector having the corresponding number of surfaces, each of which has one hole having the internal surface to receive the screw to be fixed together.

According to still other preferred embodiment of the present invention, the subsidiary connector member to be used for connecting PET bottles 10 comprises a circular or polyhedral type of tubular or cylindrical connector body, both external side of which each screw-binding section is provided, both internal side of which each screw-binding section is provided, or either internal or external side of which each screw-binding section is provided, respectively, to bind two or more PET bottles in a manner of chain into the desired configuration.

Hereinafter, the function and working effect by the apparatus of the invention will be described, with reference to the accompanying drawings.

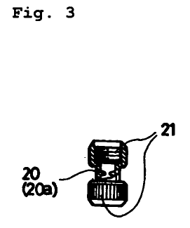

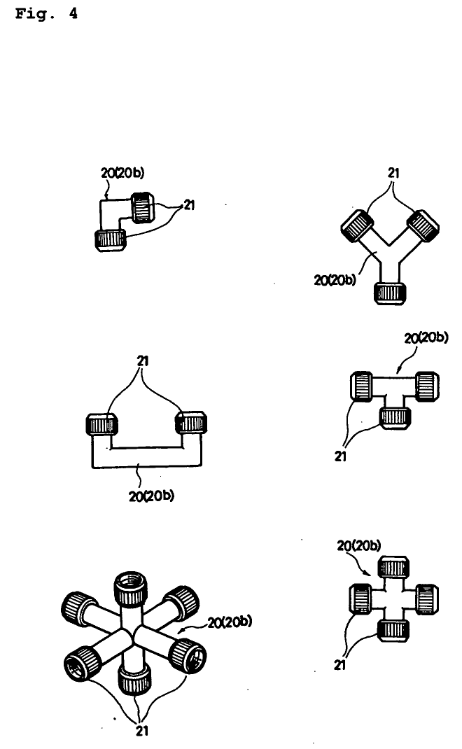

The said connector member (20) can be formed in a linear type of connector (20a) as shown in FIG. 3, having the screw type binders at both side thereof, or the polygonal type binders (20b) as shown in FIG. 4, each face of which has one screw type binder at each end, and each faces of which is refracted/bended with a various angles.

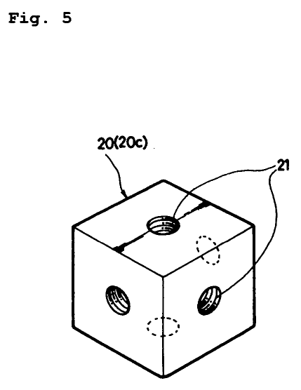

The said connector member (20) according to the invention can be formed in a polyhedral type of connector (21) as shown in FIG. 5, having the screw type concave hole for screw-binding at every face thereof.

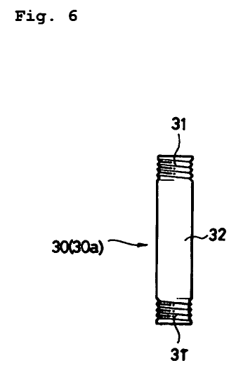

Meanwhile, when connecting/assembling the PET bottles according to the invention by use of linear type of connector (20a), polygonal type binders (20b) and/or polyhedral type of connector (20c) according to the invention, the subsidiary connector members (30) having connected/assembled body (32) made of stick- or tube-shape substance having an circular or polygonal cross-section as shown in FIGS. 6 to 8, may be used.

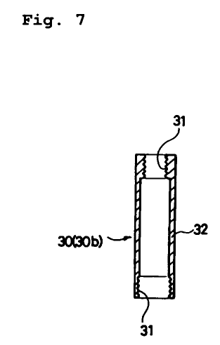

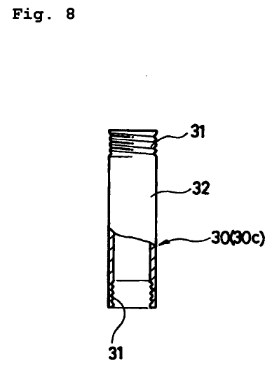

In other words, the subsidiary connector members (30) comprises a circular or polyhedral type of tubular or cylindrical connector body (32) in a shape of connecting body (31a) as shown in FIG. 6, both external side of which each screw-binding section (31) is provided with; in a shape of connecting body (31b) as shown in FIG. 7, both internal side of which each screw-binding section is provided with; or in a shape of connecting body (31c) as shown in FIG. 8, either internal or external side of which each screw-binding section is provided with, respectively, to bind two or more PET bottles in a manner of chain into the desired configuration.

Hereafter, a preferable exercise for illustrating the state is provided in which linear type of connector (20a), polygonal type binders (20b) and/or polyhedral type of connector (20c), and the subsidiary connector members (30) is used for connecting and/or assembling those PET bottles.

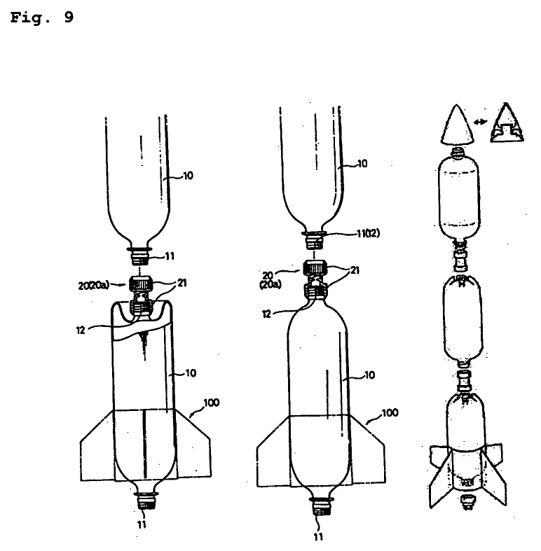

That is, a preferable embodiment for assembling a water-rocket (100) by using only the linear type of connector (20a) is provided according to the invention as shown in FIG. 9, in which a screw type connector part (21) at one end of the said linear type of connector (20a) is connected/bound to a liquid outlet mouth (11) on upper side of one PET bottle, and to a screw type connector part (21) at the other end of the said linear type of connector (20a) is connected/bound another liquid outlet mouth (12) provided downwards from beneath the other bottle (10′).

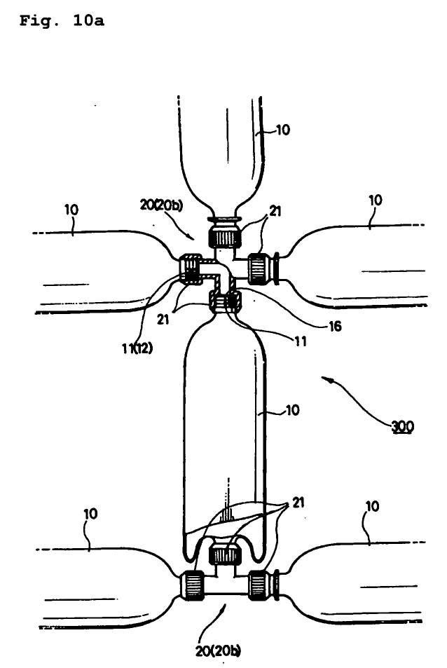

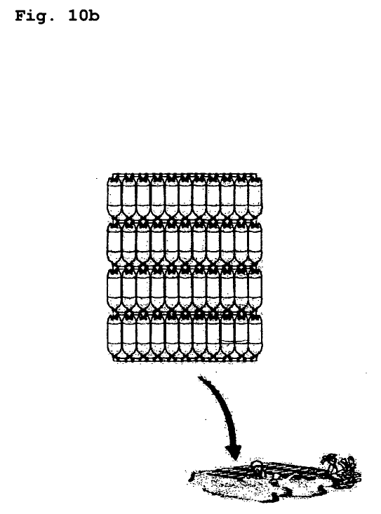

Similarly, as shown in FIGS. 10a and 10b, the floating mat or the raft (300) can be connected/assembled by selecting the necessary number of linear type connectors (20a) and/or polygonal type binders (20b), and connecting/assembling them to the liquid outlet mouths (11, 12) provided on upper/beneath side of every other PET bottles, to form a desired configuration. For this configuration, of course, the said polyhedral connector member (20c) can be used.

In addition, the hollow type connector member (20) for connecting/assembling the PET bottles can have a sealing plate (16) interior side of screw-binding portion (21), in order to separate the inner air in a bottle from communicating to the other bottle, so that a danger due to air-leakage when used as the floating mat or raft (300) can be avoided by the aid of other non-leakaging bottles.

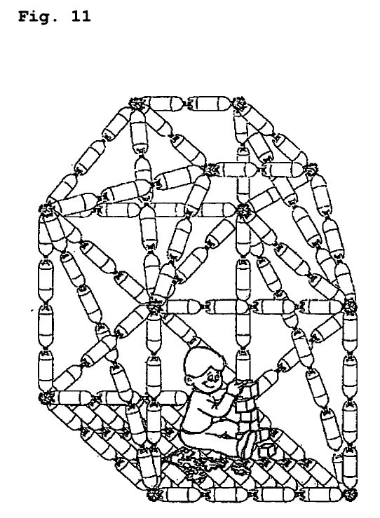

Furthermore, as seen from FIG. 11, a various shape or type of configuration can be made by the combination of linear type of connector (20a), polygonal type binders (20b) and/or polyhedral type of connector (20c), and the subsidiary connector members (31a,31b,31c) having a various shapes. Therefore, the invention may find an application for a teaching material to promote the creativeness of young students.

Moreover, if the aforementioned use is no more desired, the construction connected/assembled according to the invention can easily be disassembled and separated into the respective members, such as linear type of connector (20a), polygonal type binders (20b) and/or polyhedral type of connector (20c), the subsidiary connector members (31a,31b,31c) having a various shapes, and many PET bottles according to the invention. This will reduce total volume of every members rather than those in the assembled form, thereby promoting the easy carrying.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. A bottle and connector assembly, comprising:
at least one bottle, the bottle comprising
an upper part forming a first liquid outlet mouth adapted to be sealed with a stopper, and
a lower part having a second liquid outlet mouth adapted to be sealed with stopper; and
at least one connector member having at least a first connecting portion and a second connecting portion, the first connecting portion and the second connecting portion both being connectable to either one of the first and the second liquid outlet mouth.

2. The assembly according to claim 1, wherein each of the at least one connector member comprises a linear connector, the first connecting portion and the second connecting portion both being provided with an internal thread.

3. The assembly according to claim 1, wherein each of the at least one connector member has more than two connecting portions, each connecting portion being connectable to either one of the first and the second liquid outlet mouth.

4. The assembly according to claim 1, wherein the connecting portions each includes a hole having an internal thread.

5. The assembly according to claim 1, further comprising at least one subsidiary connector member, the subsidiary connector member having a first subsidiary connecting portion and a second subsidiary connecting portion, the first subsidiary connecting portion and the second subsidiary connecting portion each being connectable to one of either one of the first and the second liquid outlet mouth at least one of the first and either one of the first and the second connecting portion.

6. The assembly according to claim 5, wherein connector members, subsidiary connector members and bottles are adapted to be connected to form a three-dimensional structure.

7. The assembly according to claim 1, wherein the second liquid outlet mouth is disposed on an opposite end of the bottle from the first liquid outlet mouth.

8. The assembly according to claim 7, wherein the second liquid outlet mouth is disposed in a recess in the lower part of the bottle.

9. The assembly according to claim 1, wherein the second liquid outlet mouth is disposed in a recess in the lower part of the bottle.

10. The assembly according to claim 1, wherein the at least one connector member is linear.

11. The assembly according to claim 1, wherein the first and second connector portions are both internally threaded.

12. The assembly according to claim 1, wherein, when a first bottle is connected at either one of the first and the second liquid outlet mouth thereof to the first connector portion of the at least one connector member and a second bottle is connected at either one of the first and the second liquid outlet mouth thereof to the second connector portion of the at least one connector member, a central axis of the first bottle is substantially aligned with a central axis of the second bottle.

13. The assembly according to claim 1, wherein, when a first bottle is connected at either one of the first and the second liquid outlet mouth thereof to the first connector portion of the at least one connector member and a second bottle is connected at either one of the first and the second liquid outlet mouth thereof to the second connector portion of the at least one connector member, a central axis of the first bottle defines a non-zero angle with a central axis of the second bottle.

14. The assembly according to claim 1, comprising a bottle connected at either one of the first and the second liquid outlet mouth thereof to the first connector portion, the second connector portion, and at least one additional connector portion of the at least one connector member.

15. The assembly according to claim 14, wherein a central axis of a first one of the bottles defines a non-zero angle with a central axis of a second one of the bottles.

16. The assembly according to claim 15, wherein a central axis of a first one of the bottles is aligned with a central axis of a third one of the bottles.

17. The assembly according to claim 14, wherein a central axis of a first one of the bottles is aligned with a central axis of a second one of the bottles.

18. A bottle, comprising:
an upper part forming a first liquid outlet mouth adapted to be sealed with a stopper; and
a lower part having a second liquid outlet mouth adapted to be sealed with stopper.

19. The assembly according to claim 18, wherein the second liquid outlet mouth is disposed on an opposite end of the bottle from the first liquid outlet mouth.

20. The assembly according to claim 18, wherein the second liquid outlet mouth is disposed in a recess in the lower part of the bottle.
